(19) United States
(12) Patent Application Publication
(10) Pub. No.: US 2001/0016994 A1
(43) Pub. Date: Aug. 30, 2001

(54) Garment hanger having a removable size indicator

(75) Inventors: Stanley F. Gouldson, Northport, NY (US); Olaf Olk, Hauppauge, NY (US)

Correspondence Address: Scully, Scott, Murphy & Presser, 400 Garden City Plaza, Garden City, NY, 11530, US

(73) Assignee: SPOTLESS PLASTICS PTY. LTD., Victoria (AU)

(21) Appl. No.: 09/852,190

(22) Filed: May 9, 2001

Related U.S. Application Data
(62) Division of application No. 09/571,603, filed on May 15, 2000, now Pat. No. 6,260,745.
Application No. 09/571,603 is a continuation-in-part of application No. 09/479,170, filed on Jan. 7, 2000.

(51) Int. Cl. G09F 3/00

(52) U.S. Cl. 40/322; 40/666

(57) ABSTRACT

A garment hanger having a releasable size indicator. The garment hanger including a hook for suspending the hanger on a support and a body connected to the hook; the hanger having at least one web for removably securing a size indicator to the hanger, the web having a fixed latch and a pivoting latch; and a size indicator having at least one engagement abutment and fingers for engaging the fixed and pivoting latches such that the size indicator is secured on the web during normal use, but wherein the size indicator may be released from the web when the pivoting latch is pivoted out of engagement with the fingers of the size indicator.

### CROSS REFERENCE TO RELATED APPLICATIONS

This application is a continuation-in-part of U.S. application Ser. No. 09/479,170 filed Jan. 7, 2000.

### BACKGROUND OF THE INVENTION

1. Field of the Invention

The present invention relates generally to a garment hanger of the type having a removable size indicator and, more particularly, to a garment hanger having a size indicator which may be removed by way of a tool which engages a pivoting latch.

2. Prior Art

U.S. Pat. No. 3,949,914 illustrates a hanger with a modified hook which accepts a size indicator which clips onto one of the flanges which define the hook structure.

U.S. Pat. No. 4,115,940 illustrates a hanger having a size indicator or sizing tab which attaches to a tab mounting member mounted between the hanger hook and the hanger body. Hangers having size indicators mounted in this position are generally referred to in the trade as side sizers.

U.S. Pat. No. 4,322,902 illustrates a hanger having a display portion formed at the top of the hook which may accept two different types of size indicators. One type fastens to the display portion like a tie-tac, and the other slips over the top of the display portion. Hangers having size indicators mounted in this position are generally referred to in the trade as top sizers.

U.S. Pat. No. 5,485,943 is typical of a number of patents which disclose one or more means to prevent inadvertent removal of the side sizer by blocking access to the edges of the side sizer, thereby preventing young children from obtaining “finger purchase” on the edge of the side sizer to pry it off.

U.S. Pat. Nos. 5,469,995; 5,778,575; 5,469,995; 5,096,101; 5,950,883; 5,683,018; 5,642,840; 5,611,469; and 5,407,109 all illustrate hangers having various means to make the side sizer “substantially unremovable” or “irremovable” once the sizing tab engages the tab holder on the hanger. The intent is to make the hanger and sizing system “child proof”, and thereby prevent a child from inadvertently removing the tab, and swallowing or choking on the side sizer.

U.S. Pat. No. 5,449,099 is one of several patents on a hanger and side sizer system that provides a tool for removing the side sizer if it is inadvertently applied, or if the hanger is later used to hang a garment of a different size. Multiple cuts are provided through the security rib and the attachment member to enable a special tool to pry the indicator from the hanger.

U.S. Pat. No. 5,687,887 illustrates another design for a hanger and side sizer that enables a special tool to slide through cuts in the security rib and thereby remove the side sizer.

U.S. Pat. No. 5,794,363 illustrates a hanger hook adapted to receive a top sizer, which hanger hook has a resilient detent engagement means for securing the top sizer which enables the top sizer to be automatically removed for re-use of the hanger.

### SUMMARY OF THE INVENTION

It is an object of the present invention to provide a garment hanger with a novel size indicator and indicator attachment mechanism.

It is a further object of the present invention to provide a garment hanger with a removable size indicator.

It is yet a further object of the present invention to provide a garment hanger with a removable size indicator that may be mounted on the top of the hook or at the side of the hook.

It is still yet a further object of the present invention to provide a garment hanger with a removable size indicator that is securely affixed to the hanger during use, and is thereby “child proof”, yet which may be quickly and easily removed with a tool when it is desired to re-use the hanger with a garment of a different size.

Accordingly, a garment hanger having a removable size indicator is provided. The garment hanger comprises: a hanging means for suspending the hanger on a support and a body connected to the hanging means; the hanger having at least one web for removably securing a size indicator to the hanger, the web having a fixed latch and a pivoting latch; and a size indicator having finger means for engaging the fixed and pivoting latches such that the size indicator is secured on the web, wherein the size indicator is released from the web when the pivoting latch is pivoted out of engagement with the finger means of the size indicator.

In a preferred implementation of the garment hanger of the present invention, the size indicator further comprises at least one engagement abutment disposed on an inner surface of the size indicator. More preferably, the at least one engagement abutment comprises a first engagement abutment disposed on a first inner surface of the size indicator and a second engagement abutment disposed on a second inner wall of the size indicator.

In another preferred implementation of the garment hanger of the present invention, the hanging means is a hook and the web is located at either, a junction between the hook and the body, at a top portion of the hook, or at both locations.

In yet another preferred implementation of the garment hanger of the present invention, the pivoting latch is located at a central portion of the web and the fixed latch is located on at least one end of the pivoting latch. Preferably, the fixed latch is located on each end of the pivoting latch, with the pivoting latch projecting from a first side of the web and the fixed latch projecting from an opposite side of the web.

In still yet another preferred implementation of the garment hanger of the present invention, the pivoting latch is defined by a slot cut through the web, the slot having a shape defined by at least two sides, the pivoting latch being further defined by a living hinge closing the shape of the slot. Preferably, the slot is two sided and the living hinge closes the shape of the slot thereby forming a triangular shaped pivoting latch. The pivoting latch further having an engagement means for facilitating the pivoting of the pivoting latch. Preferably, the engagement means comprises a cantilevered end of the pivoting latch which when a releasing force is applied thereto provides a mechanical advantage for pivoting the pivoting latch out of engagement with at least one engagement abutment and finger means of the size indicator. The web further has a guard extending across the web and below the size indicator, the guard having a down-turned portion which follows the contours of the cantilevered end. The guard protects the cantilevered end from inadvertent actuation. The cantilevered end preferably has engagement means adapted to receive a tool used for application of the releasing force. The engagement means is preferably a dimple formed on a side of the cantilevered end.

In a preferred implementation of the garment hanger of the present invention, the size indicator preferably has a face and two sides depending therefrom, each of the sides terminating in a foremost edge, the foremost edges being configured such that the cantilevered end of the pivoting latch is exposed when the size indicator is secured on the web. The finger means of the size indicator preferably comprises an inwardly facing ridge disposed at each of the foremost edges and projecting inwards towards the channel. The at least one engagement abutment is preferably disposed on each of an inner surface of the two sides between the face and the foremost edge.

In yet another preferred implementation of the garment hanger of the present invention, the web further comprises an outermost edge having an outermost portion of a predetermined cross-section, the size indicator having a pair of spaced projections projecting from an inner surface of the face and substantially configured to receive an outermost portion of the web therebetween for preventing a lateral movement of the size indicator when the size indicator is secured on the web.

In still yet another preferred implementation of the garment hanger of the present invention, the web further comprises locating guides for locating the size indicator in a predetermined position on the web. The locating guides preferably comprise first and second guides disposed on each of the side edges of the size indicator and spaced apart to fit the size indicator therein to center the size indicator between the guides when it is applied. Preferably each of the first and second guides do not extend the full length of the side of the size indicator.

Still yet provided is a size indicator to be removably secured to a web of a garment hanger. The size indicator comprises a face and two sides depending therefrom defining a channel, each of the sides terminating in a foremost edge, an inner surface of the face having a pair of spaced projections substantially configured to receive an outermost portion of the web therebetween for preventing a lateral movement of the size indicator when the size indicator is secured on the web. Each of the sides have at least one engagement abutment disposed between the face and foremost edge and an inwardly facing ridge disposed at each of the foremost edges and projecting inwards towards the channel for engaging a fixed ridge and a pivoting ridge on the web. The cross section of the size indicator enables the size indicator to be extruded and then cut into sections. The indicators may be printed before or after cutting. This process substantially lowers the cost of producing size indicators as compared to the cost of producing indicators which must be individually molded.

In one embodiment of the invention, a hanger hook is provided which has provisions for receiving either a side sizer or a top sizer as desired. This reduces the inventory of hangers required for a garment manufacturer who ships to both types of retail environments, i.e., retail stores which desire side sizers, and those who desire top sizers. Alternately, if desired, both could be affixed to the hook. In this embodiment, the top sizer is longer than the side sizer to provide greater visibility and visual harmony with other top sizer hangers, although the top web and the side web could be formed to receive the same length of size indicator, thereby allowing the manufacturer to use the same size indicator as either a side sizer or a top sizer.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a first embodiment of a garment hanger of the present invention having a first web at a junction between the hook and body of the garment hanger.

FIGS. 2(a) and 2(c) illustrate an end view of a first and second version, respectively, of a first embodiment of a size indicator of the present invention for engaging the first web of FIG. 1.

FIG. 2(b) illustrates a top view of the size indicators of FIGS. 2(a) and 2(c).

FIG. 3(a) illustrates an enlarged view of the first web of FIG. 1.

FIG. 3(b) illustrates the enlarged view of the web of FIG. 3a with a size indicator secured thereon.

FIG. 4 illustrates a partial sectional view of the first web of FIG. 3 as taken along line 4-4 thereof.

FIG. 5 illustrates a partial sectional view of the web of FIG. 3. as taken along line 5-5 thereof, the movement of the pivoting latch illustrated therein by a broken line.

FIG. 6(a) illustrates a partial sectional view of the web of FIG. 3 as taken along line 5-5 thereof and additionally having the first version of the size indicator secured thereon.

FIG. 7(a) illustrates the first web and first version of the first embodiment of the size indicator of FIG. 6(a) wherein the pivoting latch is being pivoted to release the size indicator therefrom.

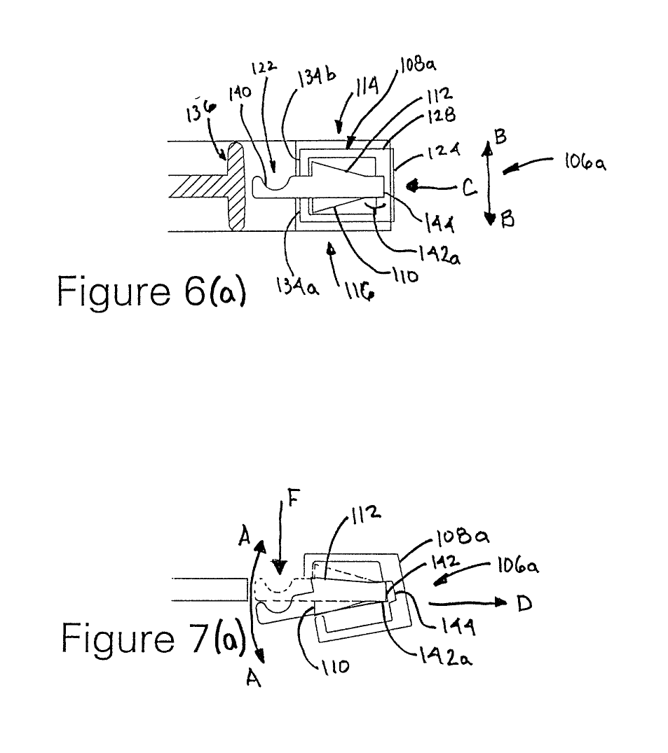

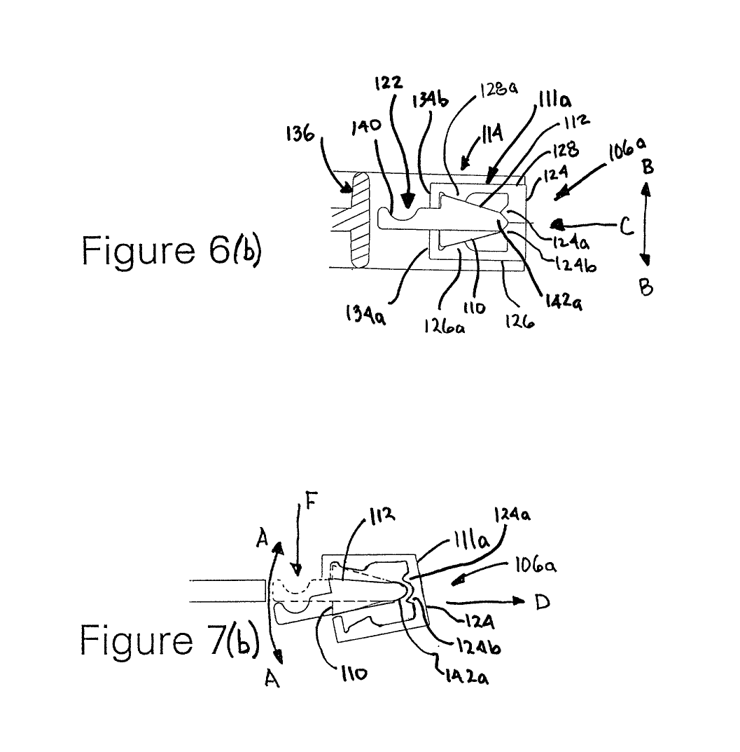

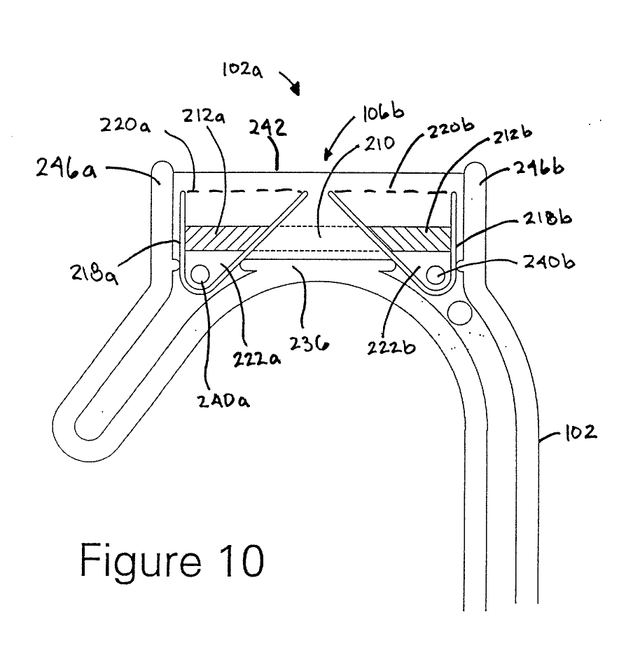

FIG. 6(b) illustrates a partial sectional view of the web of FIG. 3 as taken along line 5-5 thereof and additionally having the second version of the size indicator secured thereon.

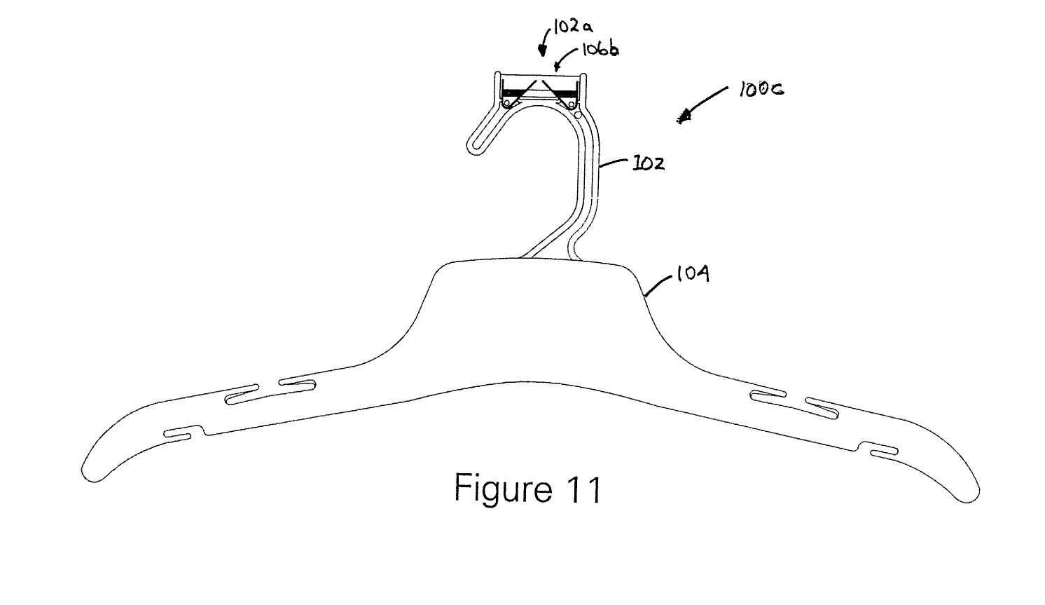

FIG. 7(b) illustrates the first web and second version of the first embodiment of the size indicator of FIG. 6(b) wherein the pivoting latch is being pivoted to release the size indicator therefrom.

FIG. 8 illustrates a second embodiment of a garment hanger of the present invention having the first web at a junction between the hook and body of the garment hanger and a second web at a top portion of the hook.

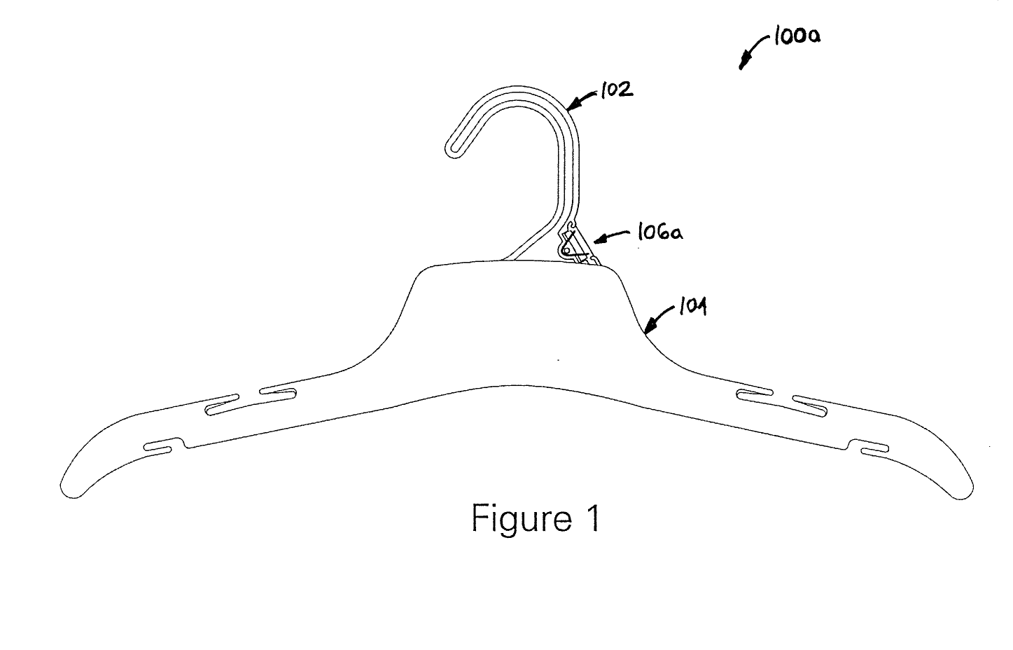

FIGS. 9(a) and 9(c) illustrate an end view of a first and second version, respectively, of a second embodiment of a size indicator of the present invention for engaging the second web of FIG. 1.

FIG. 9(b) illustrates a side view of the size indicators of FIGS. 9(a) and 9(c).

FIG. 10 illustrates an enlarged view of the second web of FIG. 1.

FIG. 11 illustrates a third embodiment of a garment hanger of the present invention having the second web at the top portion of the hook.

### DETAILED DESCRIPTION OF THE PREFERRED EMBODIMENT

Although this invention is applicable to numerous and various types of hangers, it has been found particularly useful in the environment of garment hangers having a hook for suspending the garment hanger from a display. Therefore, without limiting the applicability of the invention to these types of hangers, the invention will be described in such environment.

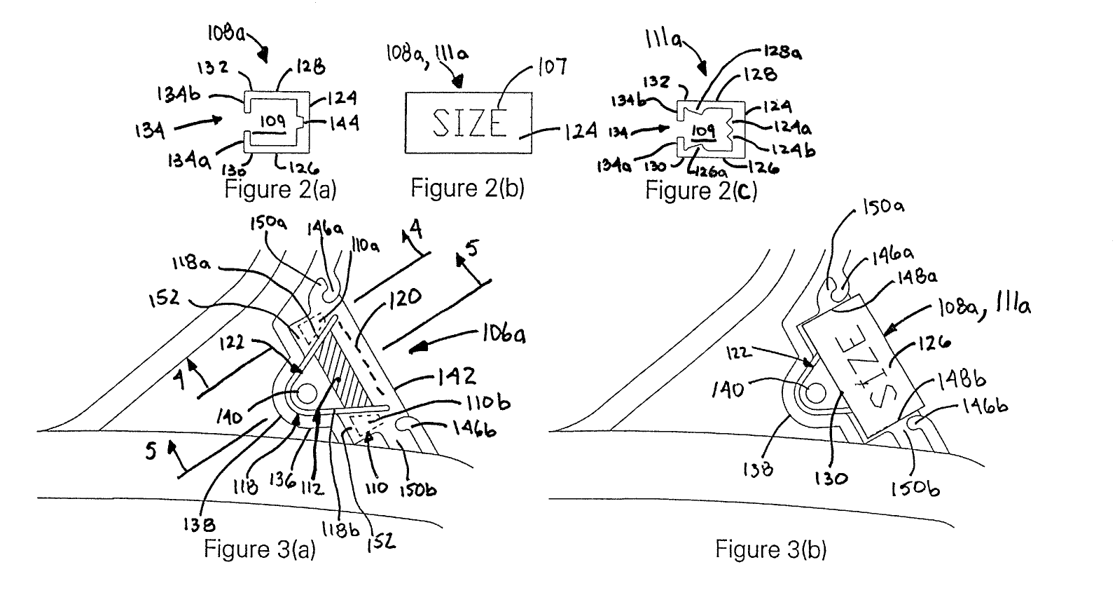

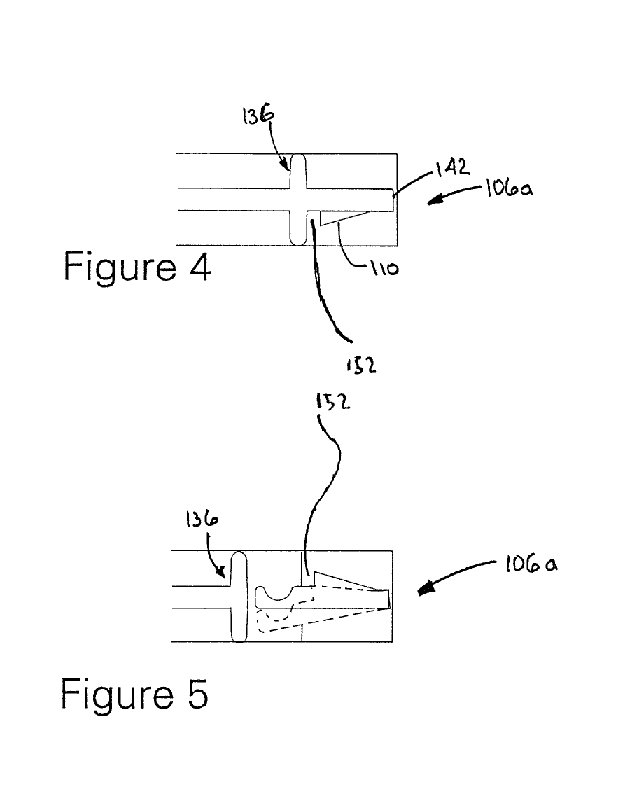

Referring now to FIG. 1, there is illustrated a first embodiment of the garment hanger of the present invention, generally referred to by reference numeral 100a. The garment hanger 100a has a hanging means, such as a hook 102, for supporting the hanger 100a on a display (not shown). The hanger 100a further having a body 104 connected to the hook 102. The body has at least one web 106a for removably securing a first version of a first embodiment of a size indicator 108a (FIG. 2a) to the body 104. In a first embodiment of the garment hanger of the present invention, illustrated in FIG. 1, the web 106a is located at a junction between the hook 102 and the body 104. As will be discussed below with regard to FIG. 8, in a second embodiment of the garment hanger of the present invention, generally referred to by reference numeral 100b, the web 106b can be alternatively located at a top portion 102a of the hook 102. Furthermore, as will be discussed below with regard to FIG. 11, in a third embodiment of the garment hanger of the present invention, generally referred to by reference numeral 100c, the web 106b can be alternatively located at both the junction between the hook 102 and the body 104 and at the top portion 102a of the hook 102.

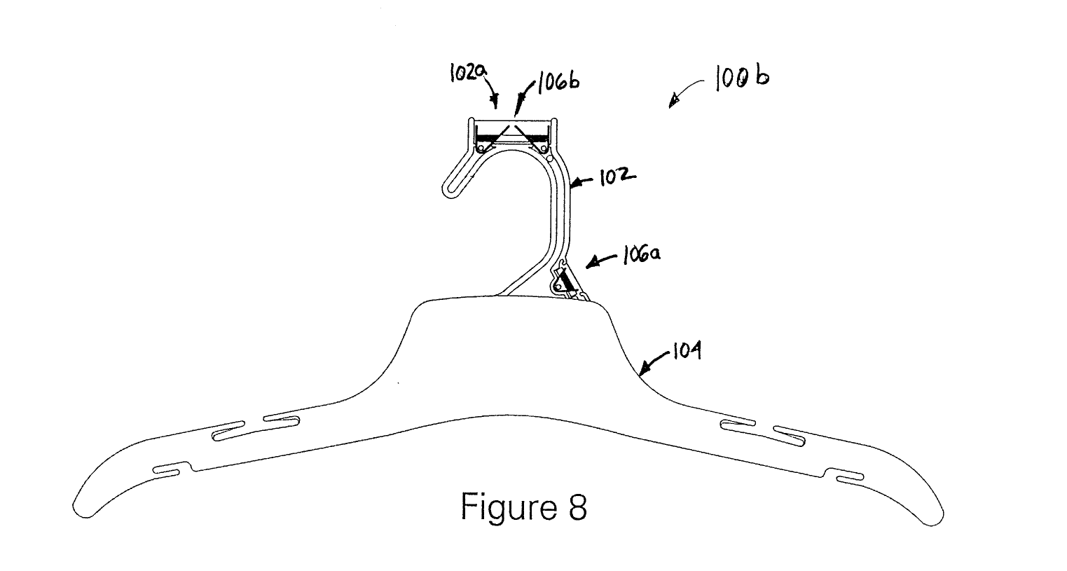

Referring Now to FIG. 3a, the web has a fixed latch 110 and a pivoting latch 112. The pivoting latch 112 is preferably located at a central portion of the web 106a and the fixed latch 110 is located on at least one end of the pivoting latch 112. Preferably, the fixed latch 110, as shown in FIG. 3, comprises two abutments 110a, 110b located on each end of the pivoting latch 112. As illustrated in FIGS. 4-7, and most clearly in FIGS. 6a and 6b, it is also preferable that the pivoting latch 112 projects from a first side 114 of the web 106a and the fixed latch 110 projects from an opposite side 116 of the web 106a.

Referring back to FIG. 3a, the pivoting latch 112 is preferably defined by a slot 118 cut through the web 106a. The slot preferably has a shape defined by at least two sides 118a, 118b. The pivoting latch 112 is further defined by a living hinge, shown by dotted line 120 closing the shape of the slot 118. As shown in FIG. 3a, the slot 118 is preferably substantially two sided 118a, 118b and the living hinge 120 closes the shape of the slot 118 thereby forming a triangular shaped pivoting latch 112. It should be apparent to those skilled in the art that the pivoting latch and the slot defining the shape thereof, can have a variety of shapes, such as rectangular, without departing from the scope or spirit of the present invention.

Referring now to FIGS. 3a, 3b, and 6a in combination, the pivoting latch 112 preferably has an engagement means for facilitating movement of the pivoting latch about arrow A shown in FIGS. 7a and 7b. The engagement means preferably comprises a cantilevered end 122 of the pivoting latch 112 which when a releasing force (F) is applied thereto provides a mechanical advantage for movement of the pivoting latch 112 out of engagement with the size indicator. Simultaneously, the opposite side of the pivoting latch 112 displaces the size indicator such that it no longer engages the fixed latch 110.

Referring now to FIGS. 2a, 2b, and 6a in combination, a first version of the size indicator 108a of the first embodiment generally has a face 124 and two sides 126, 128 depending therefrom to form a generally C-shaped channel 109. Each of the sides 126, 128 terminate in a foremost edge 130, 132. The foremost edges 130, 132 are preferably configured such that the cantilevered end 122 of the pivoting latch 112 is exposed when the size indicator 108a is secured on the web 106a.

The size indicator 108a further having finger means 134 for engaging the fixed and pivoting latches 110, 112, respectively, such that the size indicator 108a is secured on the web during normal use. However, the size indicator 108a is releasably secured on the web 106a such that it may be released from the web 106a when the pivoting latch 112 is pivoted out of engagement with the finger means 134 of the size indicator 108a when the release force (F) is applied. The finger means 134 preferably comprises an inwardly facing ridge 134a, 134b disposed at each of the foremost edges 130, 132 and projecting inwards towards the channel 109 of the size indicator 108a.

In an alternative version, a second size indicator of the first embodiment is illustrated in FIG. 2c in which like reference numerals refer to similar features, the second size indicator being referred to generally by reference numeral 111a. The second size indicator 111a has engagement abutments 126a and 128a which protrude from the inside of the sides 126, 128, respectively, to touch the side walls of the fixed and pivoting latches 110, 112 when secured to the web 106a. As will be discussed below, the size indicator 111a further has a pair of spaced projections 124a, 124b projecting from an inner surface of the face 124.

Referring back to FIGS. 3a and 6a in combination, the web preferably also has a guard 136 extending across the web 106a and below the size indicator 108a. In a preferred implementation, the guard 136 has a down-turned portion 138 which follows the contours of the cantilevered end 122 to thereby enable access to the edges of the size indicator and the engagement means 122 but prevents inadvertent actuation of the pivoting latch 112. The cantilevered end and engagement means 122 are preferably configured to engage a tool (not shown) used for application of the releasing force (F). The engagement means is preferably a dimple 140 formed on a side of the cantilevered end 122. The tool having a tip substantially conforming to the shape of the dimple 140 and having a width such that it is not prevented from engaging the dimple 140 by the guard 136.

The web preferably also has an outermost edge 142 having an outermost portion 142a of a predetermined cross-section. The first version of the size indicator 108a having a trough 144 (FIG. 2a) with a mating cross-section substantially configured to receive the outermost portion 142a therein for preventing a lateral movement of the size indicator along direction B-B when the size indicator 108a is secured on the web 106a. The preferable predetermined cross-section of both the outermost portion 142a and the trough 144 is substantially rectangular. The second version of the size indicator 111a having first and second spaced projections 124a and 124b, respectively, which project from the inner surface of the face 124. The first and second projections 124a, 124b are spaced such that the outermost portion 142a is accepted therein when the size indicator 111a is secured on the web 106a to prevent lateral movement of the size indicator 111a along direction B-B (illustrated in FIG. 6).

The engagement abutments 126a, 128a cooperate with the trough 144 or the first and second spaced projections 124a, 124b to prevent side to side movement of the size indicator on the web and contribute to a secure and solid attachment of the size indicator tot he hanger.

Referring to FIG. 3b, the web 106a further comprises locating means for locating the size indicator 108a, 111a in a predetermined position on the web 106a. The locating means preferably comprises first and second guides 146a, 146b disposed adjacent each side edge 148a, 148b of the size indicator 108a, 111a and spaced apart to align the size indicator 108a, 111a therebetween and to center the size indicator 108a, 111a during application thereof on the web 106a. Preferably, the first and second guides 146a, 146b do not extend the full length of the side edges 148a, 148b of the size indicator but define elongate openings 150a, 150b which expose the side edges 148a, 148b of the size indicator.

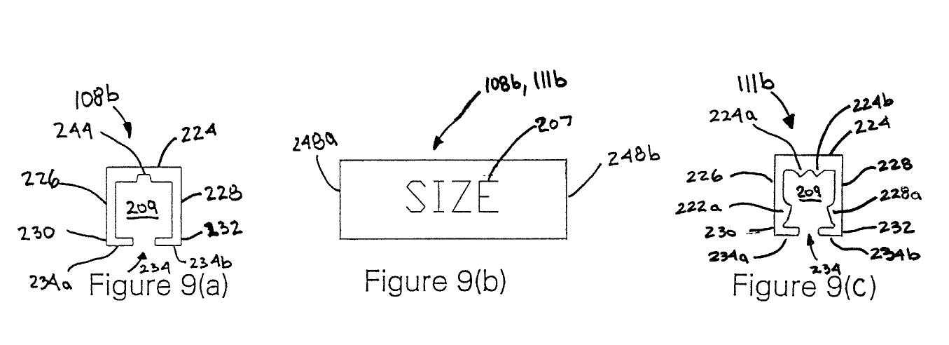

Referring now to FIGS. 6a and 7a, the operation of the garment hanger 100a of the present invention will be explained with regard to size indicator 108a. Size indicator 108a is mounted on the web 106a by sliding it over web 106a in the direction of arrow C. While being mounted in the direction of arrow C, the pivoting latch 112 pivots in the direction of arrow A until the inwardly facing ridges 134a, 134b of finger means 134 pass over the fixed and pivoting ridges 110, 112. After which, the inwardly facing fingers 134a, 134b snap into place in an area defined by the guide 136 and a bottom edge of the fixed and pivoting ridges 110, 112, the area being referenced by reference numeral 152 (illustrated in FIGS. 4 and 5). As such, the size indicator 108a is releasably secured on the web 106a.

Referring now to FIGS. 6b and 7b, the operation of the garment hanger 100a of the present invention will be explained with regard to second version of the first embodiment of the size indicator 111a. Similar to the manner in which size indicator 108a is mounted, size indicator 111a is mounted on the web 106a by sliding it in the direction of arrow C over web 106b. While being mounted in the direction of arrow C, the pivoting latch 112 pivots in the direction of arrow A until the inwardly facing ridges 134a, 134b of finger means 134 pass over the fixed and pivoting ridges 110, 112. After which, the inwardly facing fingers 134a, 134b snap into place in an area defined by the guide 136 and a bottom edge of the fixed and pivoting ridges 110, 112, the area being referenced by reference numeral 152 (illustrated in FIGS. 4 and 5). Simultaneously, the engagement abutments 126a and 128a touch and engage with a face of the fixed and pivoting latches, 110, 112, respectively. As such, the size indicator 111a is releasably secured on the web 106a.

To release the size indicators 108a, 111a from the web 106a, a releasing force (F) is applied to the cantilevered end 122 of the pivoting latch 112, preferably by engaging the dimple 140 thereon with a release tool (not shown). The release force (F) results in the pivoting latch 112 to pivot about the living hinge 120 in the direction of arrow A. As can be seen in FIGS. 7a and 7b, planar side wall of the pivoting latch 112 causes the inner ridge 134a of the finger means 134 of size indicators 108a, 111a to extend past the furthest extending portion of the fixed latch 110. At this point, the size indicator 108a, 111a may be manually removed from the web 106a.

Preferably, the size indicators 108a, 111a are fabricated from a resilient material and thereby the sides 126, 128 may be slightly biased towards each other. Thus, when the side 126 of the size indicator 108a, 111a extends past the furthest extending portion of the fixed latch 110 the resilient bias of the size indicator 108a, 111a pops the size indicator off of the web automatically, without further manual intervention.

Preliminary testing of the releasable size indicators 108a, 111a of the present invention has indicated that a force of approximately 25-30 pounds is needed to pull the size indicators from the latches of the web. Thus, the size indicators 108a, 111a of the present invention are considered to be child-proof, since industry standards require a minimum force of 15 pounds to pull off a size indicator from a hanger for the size indicator to be considered child-proof.

Referring now to FIGS. 8, 9a, 9b, and 10, there is illustrated a second embodiment of the garment hanger of the present invention, generally referred to by reference numeral 100b and in which like reference numeral denote like elements as previously discussed. The garment hanger 100b differs from garment hanger 100a illustrated in FIG. 1 in that a second web 106b is disposed at a top portion 102a of the hook 102. Generally, the second web 106b differs from the first web 106a by the inclusion of first and second pivoting latches 212a, 212b.

Referring Now to FIG. 10, the web 106b has a fixed latch 210 and first and second pivoting latches 212a, 212b. The fixed latch 210 is preferably located at a central portion of the web 106b and each of the pivoting latches 212a, 212b is located each end of the fixed latch 210. As with hanger 100a it is preferable that the pivoting latches 212a, 212b project from a first side of the web 106b and the fixed latch 210 project from an opposite side of the web 106b.

Referring back to FIG. 10, each pivoting latch 212a, 212b is preferably defined by a slot 218a, 218b cut through the web 106b. Each slot preferably has a triangular shape as discussed above with regard to hanger 10a. Each slot 218a, 218b is defined by a living hinge, shown by dotted lines 220a, 220b closing the shape of each slot 218a, 218b.

As discussed above with regard to hanger 100a, each pivoting latch 212a, 212b preferably has an engagement means for facilitating movement of the pivoting latch. The engagement means preferably comprises a cantilevered end 222a, 222b of the pivoting latch 212a, 212b which when the releasing force (F) is applied thereto provides a mechanical advantage for movement of each pivoting latch 212a, 212b out of engagement with a first or second version of a second embodiment of a size indicator 108b, 111b, respectively.

Referring now to FIGS. 9a and 9b, in combination, the first version of the second embodiment of the size indicator 108b generally has a face 224 and two sides 226, 228 depending therefrom to form a generally C-shaped channel 209. Each of the sides 226, 228 terminate in a foremost edge 230, 232. The foremost edges 230, 232 are preferably configured such that the cantilevered end 222a, 222b of each of the pivoting latches 212a, 212b are exposed when the size indicator 108b is secured on the web 106b.

In an alternative version, a second size indicator of the second embodiment is illustrated in FIG. 9c in which like reference numerals refer to similar features, the second size indicator of the second embodiment being referred to generally by reference numeral 111b. The second size indicator 111b has engagement abutments 226a and 228a which protrude from the inside of the sides 226, 228, respectively.

The first and second size indicators 108b, 111b of the second embodiment further have finger means 234 for engaging the fixed and pivoting latches 210, 212a, and 212b, respectively, such that the size indicators 108b, 111b are secured on the web 106b during normal use. However, the size indicators 108b, 111b are releasably secured on the web 106b such that they may be released from the web 106b when both of the pivoting latches 212a, 212b are pivoted out of engagement with the finger means 234 of the size indicators 108b, 111b when a release force is applied. The finger means 234 preferably comprises inwardly facing ridges 234a, 234b disposed at each of the foremost edges 230, 232 and projecting inwards towards the channel 209 of the size indicators 108b, 111b.

Although a size indication can be disposed on either the top or side surfaces of the second size indicators 108b, 111b of the second embodiment, it is preferable that the size indicators 108a, 111a of the first embodiment have the size indication 107 disposed on the face 124 of the size indicator 108a, 111a, and the size indicators 108b, 111b of the second embodiment have the size indication 207 on both sides 226, 228 of the size indicator 108b, 111b.

Referring to FIG. 10, the web 106b preferably also has a mounting hedge 236 extending partially across the web 106b and below the size indicator 108b to provide external support for the edges 230, 232 of the size indicator. Each of the cantilevered ends and engagement means 222a, 222b are preferably configured to engage a tool (not shown) used for application of the releasing force (F). The engagement means is preferably a dimple 240a, 240b formed on a side of each of the cantilevered ends 222a, 222b. The tool being configured as described above with regard to hanger 100a.

The web 106b preferably also has an outermost edge 242 having an outermost portion as described with regard to hanger 100a. The size indicator 108b having a trough 244 (FIG. 9a) with a mating cross-section substantially configured to receive the outermost portion therein for preventing a lateral movement of the size indicator when the size indicator 108b is secured on the web 106b. The preferable predetermined cross-section of both the outermost portion and the trough 244 is substantially rectangular. The second version of the second embodiment of the size indicator 111b has first and second spaced projections 224a and 224b, respectively, which project from the inner surface of the face 224. The first and second projections 224a, 224b are spaced such that the outermost portion is accepted therein when the size indicator 111b is secured on the web 106a to prevent lateral movement of the size indicator 111b along direction B-B.

The web 106b further comprises locating means for locating the size indicators 108b, 111b in a predetermined position on the web 106b. The locating means are formed from reenforcing webs of the hanger hook and preferably comprises first and second guides 246a, 246b disposed adjacent each side edge 248a, 248b of the size indicators 108b, 111b and spaced apart to align the size indicators 108b, 111b therebetween and to center the size indicators 108b, 111b during application thereof on the web 106b.

The operation of the hanger 100b of the second embodiment of the present invention operates substantially equivalently to that of the hanger 100a of the first embodiment. It should be apparent to those skilled in the art that both pivoting latches 212a, 212b are pivoted by application of the release force to release the size indicators 108b, 111b from the web 106b.

FIG. 11 illustrates a hanger of a third embodiment of the present invention generally referred to by reference numeral 100c. The hanger 100c of the third embodiment of the present invention is similar to that of the second embodiment (hanger 100b) with the exception of the elimination of side sizer web 106a.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A garment hanger having a releasable size indicator, the garment hanger comprising:
a hanging means for suspending the hanger from a support and a body connected to the hanging means;
the hanger having at least one web for removably securing a size indicator to the hanger, the web having a fixed latch and a pivoting latch; and
a size indicator having finger means for engaging the fixed and pivoting latches such that the size indicator is secured on the web during normal use, but wherein the size indicator may be released from the web when the pivoting latch is pivoted out of engagement with the finger means of the size indicator.

2. The garment hanger according to claim 1, wherein the size indicator further comprises at least one engagement abutment disposed on an inner surface of the size indicator.

3. The garment hanger according to claim 1, wherein the at least one engagement abutment comprises a first engagement abutment disposed on a first inner surface of the size indicator and a second engagement abutment disposed on a second inner wall of the size indicator.

4. The garment hanger according to claim 1, wherein the hanging means is a hook and the web is located at a junction between the hook and the body.

5. The garment hanger according to claim 1, wherein the hanging means is a hook and the web is located at a top portion of the hook.

6. The garment hanger according to claim 1, wherein the pivoting latch is located at a central portion of the web and the fixed latch is located on at least one end of the pivoting latch.

7. The garment hanger according to claim 1, wherein the fixed latch further comprises two abutments located on each end of the pivoting latch.

8. The garment hanger according to claim 6, wherein the pivoting latch projects from a first side of the web and the fixed latch projects from an opposite side of the web.

9. The garment hanger according to claim 1, wherein the pivoting latch is defined by a slot cut through the web, the slot having a shape defined by at least two sides, the pivoting latch being further defined by a living hinge closing the shape of the slot.

10. The garment hanger according to claim 9, wherein the slot is substantially two sided and the living hinge closes the shape of the slot thereby forming a triangular shaped pivoting latch.

11. The garment hanger according to claim 9, further comprising an engagement means for facilitating movement of the pivoting latch.

12. The garment hanger according to claim 11, wherein the engagement means comprises a cantilevered end of the pivoting latch which when a releasing force is applied thereto provides a mechanical advantage for pivoting the pivoting latch out of engagement with the finger means of the size indicator.

13. The garment hanger according to claim 12, wherein the size indicator has a face and two sides depending therefrom, each of the sides terminating in a foremost edge, the foremost edges being configured such that the cantilevered end of the pivoting latch is exposed when the size indicator is secured on the web.

14. The garment hanger according to claim 13, wherein the web further comprises a guard extending across the web and below the size indicator, the guard having a down-turned portion which follows the contours of the cantilevered end to thereby prevent inadvertent access to the engagement means.

15. The garment hanger according to claim 12, wherein the cantilevered end and engagement means are configured to engage a tool used for application of the releasing force.

16. The garment hanger according to claim 15, wherein the engagement means is a dimple formed on a side of the cantilevered end.

17. The garment hanger according to claim 1, wherein the size indicator has a face and two sides depending therefrom defining a channel, each of the sides terminating in a foremost edge.

18. The garment hanger according to claim 17, wherein the engagement abutment is disposed on each of an inner surface of the two sides between the face and the foremost edge.

19. The garment hanger according to claim 17, wherein the finger means comprises an inwardly facing ridge disposed at each of the foremost edges and projecting inwards towards the channel.

20. The garment hanger according to claim 1, wherein the web further comprises locating means for locating the size indicator in a predetermined position on the web.

21. The garment hanger according to claim 20, wherein the locating means comprises first and second guides disposed adjacent each side edge of the size indicator and spaced apart to align the size indicator therebetween to center the size indicator during application thereof on the web.

22. The garment hanger according to claim 21, wherein the first and second guides do not extend the full length of the side edge of the size indicator.

23. A size indicator to be removably secured to a web of a garment hanger, the size indicator comprising a face and two sides depending therefrom defining a channel, each of the sides terminating in a foremost edge, the face having a pair of spaced projections substantially configured to receive an outermost portion of the web therebetween for preventing a lateral movement of the size indicator when the size indicator is secured on the web, each of the sides having an engagement abutment disposed between the face and foremost edge and an inwardly facing ridge disposed at each of the foremost edges and projecting inwards towards the channel for engaging a fixed ridge and a pivoting ridge on the web.

24. A garment hanger having a releasable size indicator, the garment hanger comprising:
a hanging means for suspending the hanger on a support and a body connected to the hanging means;
the hanger having at least one web for removably securing a size indicator to the hanger, the web having a fixed latch and two pivoting latches; and
a size indicator having finger means for engaging the fixed and pivoting latches such that the size indicator is secured on the web during normal use, but wherein the size indicator may be released from the web when the pivoting latch is pivoted out of engagement with the finger means of the size indicator.

25. The garment hanger according to claim 24, wherein the size indicator further comprises at least one engagement abutment disposed on an inner surface of the size indicator.

26. The garment hanger according to claim 24, wherein the at least one engagement abutment comprises a first engagement abutment disposed on a first inner surface of the size indicator and a second engagement abutment disposed on a second inner wall of the size indicator.

27. The garment hanger according to claim 24, wherein the hanging means is a hook and the web is located at a top portion of the hook.

28. The garment hanger according to claim 24, wherein the fixed latch is located at a central portion of the web and each of the pivoting latches is located on each end of the fixed latch.

29. The garment hanger according to claim 28, wherein each of the pivoting latches project from a first side of the web and the fixed latch projects from an opposite side of the web.

30. The garment hanger according to claim 24, wherein each of the pivoting latches is defined by a slot cut through the web, the slot having a shape defined by at least two sides, each of the pivoting latches being further defined by a living hinge closing the shape of the slot.

31. The garment hanger according to claim 30, wherein each slot is substantially two sided and each respective living hinge closes the shape of the slot thereby forming two triangular shaped pivoting latches.

32. The garment hanger according to claim 30, further comprising an engagement means for facilitating movement of each of the pivoting latches.
